(19) United States
(12) Patent Application Publication
(10) Pub. No.: US 2003/0208409 A1
(43) Pub. Date: Nov. 6, 2003

(54) Method and apparatus for diet control

(76) Inventor: James R. Mault, Evergreen, CO (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/258,770

(22) PCT Filed: Apr. 30, 2001
(86) PCT No.: PCT/US01/13928

(51) Int. Cl. G06F 17/60

(52) U.S. Cl. 705/26

(57) ABSTRACT

A portable computing device for assisting a person to locate a food retailer in view of a food preference of the person comprises a display; a wireless transceiver for communication with a communications network; a position location device; and a software application program adapted to transmit the food preference and the location of the person to a remote computer system over a communications network, to receive data from the remote computer, and to display food retail locations and menu lists complying with the food preference to the person on the display of the computing device.

### FIELD OF THE INVENTION

The invention relates to diet control using an electronic device, in particular to the use of a portable computing device in locating restaurants, ordering meals, and diet logging.

### BACKGROUND OF THE INVENTION

Diet control and weight management are of great importance to many people. For effective weight control, caloric intake needs to be managed relative to a person's total energy expenditure (TEE). TEE is the sum of a person's resting energy expenditure REE combined with the person's activity energy expenditure or AEE, i.e. TEE=REE+AEE. For weight maintenance, a person's total caloric intake needs to be the same as or less than TEE. If TEE can be measured or reasonably estimated, daily caloric intake ranges can be provided consistent with the weight control goals. However, in order for a person to comply with caloric intake goals, accurate recording of calories consumed must be performed. However, conventional diet programs and systems present difficulties when a user eats outside of their home, in particular when eating meals prepared by third parties in a restaurant. Portion sizes and nutritional content of restaurant meals are often poorly defined and unpredictable. Restaurant menus conventionally do not give any detailed nutritional information, making it difficult for a person on a weight control program to order sensibly. Low calorie meals may not be identified, or even if identified, may turn out to be poor value, unsubstantial meals.

Further, many people have food allergies, diet restrictions, or other reasons to avoid different food types or food preparation methods. These restrictions may arise from health concerns, cultural considerations, medical reasons, or some other reason. It can be difficult for a person to comply with dietary requirements. For example, locating a restaurant that offers even one meal complying with requirements may be difficult. It can further be difficult to select meals from a presented menu which comply with dietary requirements.

Even a person without strict dietary requirements would benefit considerably from a system or method which provides the person with additional information about food choices, particularly when the person is choosing from a list of meal options presented within a restaurant. The additional information can be used for selecting healthy meals, and to avoid excessive consumption.

Conventional systems allow a person to locate nearby attractions, including restaurants. However, they fail to allow a person to obtain nutritional information of food available. Further, they fail to allow a person to identify food retail locations based on dietary needs. Further, they fail to allow a person to use nutritional information received on a portable electronic device over a communications network in creating a diet log, for example for weight control purposes.

Conventional navigation advice, travel advice, and global positioning based systems are disclosed in the following U.S. patents, the contents of which are incorporated herein by reference: U.S. Pat. Nos. 5,470,233, 5,543,789, 5,699,255, 5,767,795, 5,802,492, 5,839,088, 5,848,373, 5,808,566, 5,926,116, 5,948,040, 5,959,577, 6,014,090, 6,026,375, and 6,047,236. A conventional restaurant ordering system are disclosed in the following U.S. patent, incorporated herein by reference: U.S. Pat. No. 5,838,797.

### SUMMARY OF THE INVENTION

A system is described for diet control particularly applicable to a person eating at restaurants, referred to as a user of the system. The system is useful for a user wishing to control (restrict, maintain, or increase) dietary intake of certain diet components (such as fat, fiber, sugar, salt, carbohydrates, protein, vitamins, meat, vegetarian or vegan products, dairy products, mineral (e.g. calcium, iron) containing foods, organic foods, etc.) for any purpose (or purposes), such as weight control, medical reasons, lifestyle choices, etc. The system is particularly useful for a user with weight loss or maintenance goals wishing to eat out at restaurants. Restaurants equipped to participate in this system will be referred to as participating restaurants.

Current weight management systems sometimes lack flexibility in recording caloric input, for example a cheeseburger served by different restaurants may vary considerably in caloric value, fat content, etc. and it is difficult for a person on a weight-loss program to estimate these variations. A method is described in which participating restaurants supply nutrition information to the person, allowing more a more accurate record of caloric input to be made. Apparatus capable of implementing this method is described. A business model for the implementation of the invention in a weight-loss program is described.

The user is equipped with a portable electronic device, preferably with an information display capabilities, for example a personal digital assistant (PDA) such as a PalmPilot, Handspring Visor, any other portable computer, electronic organizer, display equipped spectacles, wireless telephone, pager, electronic book, tablet computer, PocketPC, and other electronic devices. A plug-in module for a conventional PDA can be supplied, comprising a position locator (such as a GPS, or wireless triangulation method), wireless transceiver, and software configured to implement embodiments of the present invention. In this specification, a position of a person refers to a physical location of the person. Visual display of information is preferred, but other methods can be used to present information to the user, such as audio, vibrations such as audio tones, tactile effects (e.g. Braille methods). In this disclosure, the device will be referred to as a PDA, portable computer, or portable computing device, but this is non-limiting as the invention may be used with other electronic devices, such as those listed above. The portable electronic device has data communication abilities, for example via a wireless link (such as the Bluetooth protocol developed by Ericsson), optical, ultrasound, electrical, telephonic, etc.). The preferred embodiment is a PDA with Bluetooth wireless communication abilities. However, the invention is not restricted by the use of Bluetooth, as the system and method of the present invention is adaptable for use with any communications modality as discussed herein. In other embodiments, a deformable sheet, two-dimensional actuator array, or similar mechanism can be used in place of the display to provide tactile feedback to a person, such as using the Braille system.

For example, when the user (in this case, a person carrying a portable electronic device such as a PDA) enters a participating restaurant, the identity of the restaurant is communicated to the PDA, preferably using Bluetooth wireless communication (other communication methods, such as IR electrical, transfer of memory modules, modulation of ambient lighting, and the like are possible). The PDA is used to display a menu of items for that restaurant along with dietary (e.g. nutrient) and caloric information, which may be received from suitable equipment located in the restaurant, such as a computer connected to a device with Bluetooth communication abilities. Information may also be received by the PDA via a communications network such as the Internet for the particular restaurant the user has entered, or via other communication methods. The menu displayed on the PDA may include nutrition information such as fat, caloric content, fiber, sodium, protein, sugar etc. for various meal options. Nutrition information may also include parameters derived from various combinations of dietary components, such as “points” derived from fat content, fiber content, and caloric content, such as those used in the Weight Watchers program. The user can choose a meal based on this information. If the user has a caloric or other restriction (e.g. sodium content) on meal choice, the menu options presented to the user may reflect this, for example by only including meal options with less than a specified caloric or sodium content.

The portable computing device (such as a PDA) can be used to show menus from which the user may select a meal option, restricted by dietary goals and needs, such as items with less than a certain fat value. The menu can be of all items, with emphasis on preferable choices, or can be restricted by diet goals to only show items from the menu which are consistent with the user's dietary or weight loss goals. The items shown may be those with a parameter more or less than a certain value, e.g. points related to caloric, fiber and fat content such as those used in Weight Watchers programs. The items shown may be those with less than a certain sodium value, less than a certain caloric value, more than a certain fiber value, or any other restriction useful to the user. The effect of menu selections on future meal options and future weight goals may also be presented. The menu displayed may display lists of important dietary information (e.g. fat grams) along with the list of menu options.

The menu presented to the user on a display of the portable computing device (such as a PDA) can have an interactive nature. For example, it can initially suggest certain choices based on the user's dietary or weight goals. If these choices are rejected, the consequences of this decision on future meal options may be presented. The caloric content of the meal chosen may exceed the suggested level, and the effect on the caloric limit of the next meal may be illustrated. For example, if two slices of pizza are chosen for the current meal, the PDA may indicate that a salad would be required for the following meal. An exercise program, or additional activities within an existing program, can be suggested to compensate for exceeding the calorie goals with a meal. Future weight gains based on certain choices, based on caloric intake trends, may be calculated and displayed. The effect on the user's stomach could be illustrated on the PDA. The interactive nature of the menu dialog could include a discussion-like feature, in which the user is asked if they are really sure about the sensible nature of a choice. It is an important aspect of this invention that the nutrition information displayed for a chosen item is specifically for the food served in the restaurant in which the user is located, or considering visiting. The information for e.g. a cheeseburger is for a particular cheeseburger served in a participating restaurant, not for a generic item with average properties.

A portable computing device equipped with global positioning system (GPS) can be used to display the current position of the user and directions to proximate restaurants. The map may show all restaurants within a certain area (e.g. within a certain distance of the user) or only ones with menu offerings consistent with the user's dietary requirements. A global positioning system (GPS) chip may be included in the PDA to assist in the identification of the restaurant.

The PDA may include speech recognition software to interpret spoken information and commands; the PDA could respond with speech, in which case a display would not be necessary (though a display is present in the preferred embodiment). A limited information content display, such as present in a wireless telephone, may be used in connection with a limited vocabulary speech recognition system. For example, the user may speak the number (e.g. “seven”) of a menu option. Computerized speech recognition is known to be more reliable with a limited possible vocabulary. The PDA can further possess voice synthesis capabilities, so as to speak advice, directions, menus, and the like to users. The device could be used at home, before or after a visit to a restaurant, in which case a remote display device (e.g. a television) could be used. Menus displayed on the PDA may include numbers (“points”) such as those used by Weight Watchers (tm) in weight reduction programs.

Examples presented describe the invention in terms of a weight loss program. However, the invention has wider scope. For example, a person with medical need for a low sodium diet can use a portable electronic device such as a PDA to identify restaurants and menu options offering low sodium meals. The PDA could be used to identify restaurants offering particular styles of meal (e.g. vegetarian options). Other information about food retailers (such as restaurants) can be made available to a user to help the user choose one, for example reviews, prices, star ratings, seating availability, health inspection data, food preparation methods, organic ingredient use, support for socially responsible activities, language use, purchasing policies, staff treatment policies, accessibility, and the like. User preferences relating to such available information can be combined with the food preferences. The PDA may be used in conjunction with a glucose sensor monitoring the user's blood sugar levels to suggest certain menu items, a configuration useful for controlling type II diabetes. The PDA may be used in conjunction with other medical/physiological sensors (e.g. cholesterol, lipids, etc.) to suggest dietary options (e.g. low fat). The PDA may also be used in conjunction with activity monitoring devices, metabolism measuring devices, etc.

Hence, a system for assisting a person to select and locate a food retail establishment may comprise: a portable computing device having a display, a processor, a memory, a data entry mechanism (such as buttons, stylus, touch pad, voice recognition system, or other input device), a wireless transceiver adapted to communicate with a communications network (such as the Internet), a position location device (such as a global positioning system) providing a location of the user, and a database accessible by the portable computing device (preferably over the communications network), by which the locations of food retail establishments complying with the user's requirement can be located, and their location relative to the user can be presented on the display.

A software application program running on the portable computing device is adapted to receive a food preference from the person, to transmit the food preference and the location of the person to a remote computer system over the communications network, and to receive food retail data from the remote computer over the communications network. Food retail data comprises food retail locations (such as restaurant addresses) and food item data (such as descriptions as would be presented in a restaurant menu, portion size, information concerning ingredients, preparation methods, portion size, nutritional data, and modifiable elements) associated with each food retail location. The food retail locations can be displayed to the user on the display of the computing device in the form of a list, map, graphic, and the like. The software application program can be further adapted to allow the person to select a single food retailer location, and to display food item data associated with the single food retailer location in the form of a menu. Food item data can be displayed in the form of a list or table, with user-preferred levels of nutritional information displayed. Food item display can be restricted to food items consistent with the food preference (or preferences) of the person. The software can further be adapted to allow selected food item data, such as items later ordered and consumed, to be recorded in a diet log for the person.

An improved method by which a user can order food within a retail environment such as a restaurant may comprise the following steps. The user determines the identity of the restaurant, the user then downloads a food selection list for display on the portable computing device, the user then selects an item from the presented food selection list, and after receiving the item the user may transmit a charge authorization so as to allow the retail environment to bill for the supplied meal. In this case, a food selection list may be a conventional restaurant menu, and the term food also includes drinks and other consumables.

A business may provide Internet access for a user (preferably possessing a portable computing device) to a server system so as to assist the user to locate suitable restaurants. The business provides a computer server system, in communication with the Internet, having access to a database correlating food retail locations with associated food retail data. Food retail data can comprises nutritional data, food identity, prices, and any other useful information relating to foods provided at the food retail locations. The server system receives the food preference and a position of the user over the Internet, correlates the position of the person with one or more food retail locations (for example, by determining restaurants close to the user), comparing food retail data for each food retail location with the food preference, and transmitting food retail location data (such as restaurant addresses or GPS coordinates) to the person. Food retail locations transmitted are those supplying food with nutritional data conforming with the food preference. Directions, maps, charts, discount authorizations, advertisements from competing restaurants, and the like may further be transmitted to the user, and the user may further transmit reservation requests, charge authorizations, discount authorizations, and other data to the server system.

A PDA carried by the user can enter into in two-way communication with a restaurant computer located in a restaurant that the user has just entered, or is in proximity to, which can communicate the identity of the restaurant to the PDA. The PDA can then request and receive the menu and nutrition information, either from the restaurant computer or from a remote computer over a communications network such as the Internet. If the menu is received via the Internet 30, the PDA can communicate the identity of the restaurant to the remote computer to receive information specific to that restaurant. After the user has chosen a meal, the information may be communicated to the remote computer via the communications network, for example to create a diet log or expense record for the person The preferred method of communication between the PDA and the restaurant computer is a wireless link, more preferably using the Bluetooth protocol.

A business may further provide a user with a portable computing device having a location device providing a position of the person, and a wireless transceiver adapted to communicate with the Internet and to log into a server system. The user can further be provided with a software application program adapted to receive the food preference from the user, and to record foods consumed by the user in a diet log.

An improved system for allowing a user to order food within a restaurant may comprise a portable computing device having a display, data entry mechanism, and a wireless transceiver in communication with a restaurant computer. The portable computing device, in possession of the user, is adapted to receive a food selection list (such as a menu) from the restaurant computer, to display the food selection list to the user, and to transmit the chosen selection from the list to the restaurant computer. The portable computing device may further comprise a positioning device, such as a global positioning unit (GPS), so as to allow identification of the restaurant from the location of the user. An improved method for assisting a user in selecting and locating a suitable food retailer (such as a restaurant, vending location, store, or other location selling food) is as follows. The position of the user is determined, for example using a GPS, and food preferences of the user are determined, either from previously entered data or from data entered by the user. One or more food retailers consistent with the food preference expressed by the user are chosen based on geographical proximity to the user, and the locations of these food retailers are displayed to the user on the display of a portable computing device, either in the form of a map, list, or other suitable display. The position of the user may be the user's current position, or alternatively can be a future planned location of the user, so as to allow planning of meal locations within a journey. For example, this method of locating food retailers can be combined with trip planning methods, so as to allow a user to plan a journey and choose locations for food during suitable times and locations during the journey.

A further system according to the present invention comprises a portable computing device in possession of the user, having a software application program adapted to receive a food preference from the person, to store the food preference in memory, and to transmit the food preference, user identity, and other data to other devices in communication range using the transceiver. The restaurant computer has a wireless transceiver, a processor, a memory, and communicates with the portable computing device when user enters the restaurant. For example, a low power Bluetooth wireless system can be used, or other wireless network. The restaurant computer transmits food item descriptions and associated nutritional data to the portable computing device. Hence, a user can view food item descriptions and nutrition information on the display of the portable computing device, and can restrict the display to that of food item descriptions having nutritional data compliant with the food preference. The restaurant computer can be further adapted to receive the food preference from the portable computing device, and to transmit only food item descriptions having nutritional data compliant with the food preference. The restaurant computer can also receive food orders from the portable computing device, and can receive charge authorizations from the portable computing device, corresponding to payment for food items provided to the person. The portable computing device can further record food items ordered by the person, and can record nutrition data associated with ordered items in a diet log for the person.

A method for allowing a user to view nutritional data associated with available food items, within a food retail environment, comprises transmitting a position from the user's portable electronic device to a remote computer system over a communications network, the remote computer system having access to a database associating the position with a food retail identity and with a food selection list. The food retail identity may be the name of the restaurant, and the food selection list comprises food identifiers and associated nutrition data. The food retail identity and food selection list are received on the portable computing device from the remote computer over the communications network, and is displayed to the user. The remote computer system can be further adapted to receive a food order or a payment authorization from person using the portable electronic device. A food preference can be used to modify the display of the food selection list to the person. The user can store nutritional data associated with ordered food items in a diet log, hence improving the reliability of diet logging using nutritional data applicable to the meal ordered, rather than generic diet log data as are used in conventional systems.

The menu and nutrient information may also be presented to the user in the form of a normal printed menu. The PDA can be used to give advice on which options are preferable, for example through an interactive dialog. The chosen item is entered into the PDA, for example using a bar code reader, a numeric code, through wireless communication with a device in the restaurant, or some other mechanism.

The meals eaten can be registered by the PDA. Portion sizes of greater or less than a single conventional portion of an item may be entered, and the price charged scaled accordingly. The information may also be sent to an Internet site associated with the user, accessible only by the user and other authorized persons (e.g. a physician, diet counselor, etc.). Weight loss goals can be adjusted, and dietary parameters of the next meal recommended. The person ordering can specify changes to preparation, ingredients, meal components, portion sizes, and the like, if appropriate. This can be done automatically is several system embodiments described herein using the food preference entered by the person. Food preferences can include certain preparation methods, omission or addition of ingredients, portion sizes, and the like.

The PDA can also be used to record other food items consumed as part of a weight loss program. For example, if the user eats meals at home, the PDA can be used to record caloric and other information, for example using a data entry window, menu-like list of food items, or barcode reader. The user may be supplied prepackaged meals at home for which the nutrition information is known. The interactive menu can also be used for suggesting meals at home, or at nonparticipating restaurants, or snacks.

The user may also have a personal web site on the Internet where dietary trends and progress towards weight goals may be viewed. This web site may be updated by communication from the PDA after a meal has been consumed. The systems of the present invention can be used for tourism, business expense account monitoring, ordering meals by sense-impaired persons, restaurant promotion, and the like.

In other embodiments, the food retailer may be a grocery store, and a person can receive nutritional information, prices, and the like, of available items for sale.

In this specification, the term food includes meals, snacks, beverages, nutraceuticals, and all other consumables and digestibles.

In this specification, the user referred to in the examples is a person using an embodiment of the present embodiment. The user preferably carries a portable electronic device, such as a PDA, but this is not limiting as other devices may be used, such as pagers, cellular phones, e-books, and other portable electronic devices. In other embodiments, an electronic device mounted in an automobile (or other form of transport) may be used in place of the portable electronic device.

### BRIEF DESCRIPTION OF THE DRAWINGS

FIG. 1 shows a system embodiment by which a person can receive nutritional information concerning restaurant meals.

FIG. 2 shows a schematic of a conventional portable computing device which may be used in embodiments of the present invention.

FIG. 3 shows a screen display showing menu items consistent with a food preference.

FIG. 4 shows a screen display showing nutritional information relating to food available from a food retailer such as a restaurant.

FIG. 5 is a system embodiment through which a person can receive nutritional information, and order food.

FIG. 6 is a flow chart illustrating a method of ordering food in a restaurant.

FIG. 7 shows a system by which a person can receive nutrition information on a portable electronic device.

FIG. 8 is a flow chart illustrating a method of ordering food for take out or delivery.

FIG. 9 is a system embodiment through which a person receive menu information on a portable device based on physical location (position).

FIG. 10 is a flow chart illustrating a method of receiving menu information on a portable device based on physical location (position).

FIG. 11 is a further system embodiment, by which personal preferences can be used to modify a menu presentation on a portable device.

FIG. 12 shows a screen display showing a map having the position of the person and the position of the restaurant.

FIG. 13 is a system embodiment through which a person's position and food preferences are used to influence a display of information.

FIG. 14 shows a schematic illustration of a system by which a person can receive nutritional information concerning restaurant meals according to food preferences.

### DETAILED DESCRIPTION OF THE INVENTION

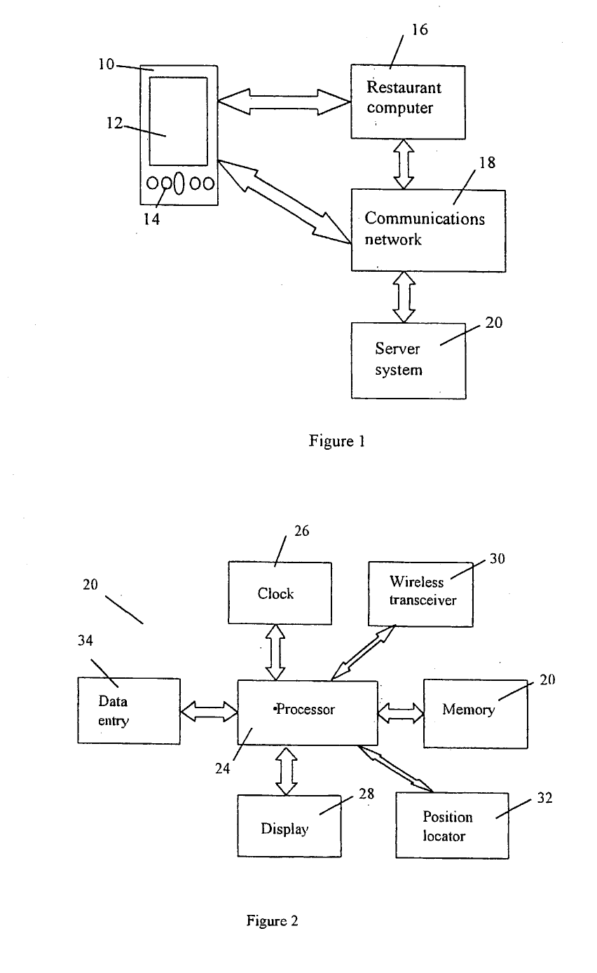

FIG. 1 is a schematic of a system which allows a user to obtain nutritional information about food choices in a food retail establishment, such as a restaurant. FIG. 1 shows a portable computing device 10 having display 12 and data entry mechanism 14 in communication with restaurant computer 16. Computers 10 and 16 are in communication through a communications network 18 with a remote computer 20, such as a server system. Portable computing device 10 may be any portable computer, such as a PDA (personal digital assistant), wireless phone with computing functionality, electronic book, pager, and the like. The data entry mechanism may comprise buttons, stylus entry, dials, touch pads, voice recognition, eye tracking, or any convenient mechanism.

FIG. 2 shows a schematic of a portable computing device 20, preferably a PDA, which may be used in embodiments of the present invention. Computing device 20 has a processor 24, a clock 26, a display 28, a wireless transceiver 30, a position locator (such as a GPS module) 32, and a data entry mechanism 34. The display 28 of the PDA 20, for example, can be used to show a menu listing, nutritional information, a map showing the location of the food retailer and the user, directions, ordering information, preparation request options to accompany an order (such as broil/fry/bake), and the like.

User Food Preferences

The dietary preferences of the user can be used to modify the presentation of menu items, for example on the display of the PDA.

The food preferences of the user can be determined from questionnaires or surveys filled out by the user, previous ordering patterns, health or weight goals of the user, and known tastes of the user. For example, the user nay express the preference to remain within a daily calorie limit, which would then restrict dinner options to those which complied with that requirement.

Food preferences may further include avoidance of dietary components due to medical, allergic, or cultural reasons, or a preference for foods low in one or more dietary components, such as salt, fat, cholesterol, lipids, meat products, lactose, or other dietary component. A food preference may be for foods high in one or more dietary component, such as vitamin C, antioxidants, fiber, or some other desirable element. A food preference can be a combination of desires, such as to avoid some diet components completely, to minimize others, while simultaneously providing high levels of other components.

A food preference may be generated by the computing device in fight of the physiological state of the user, which may include the determination hydration level, vitamin levels, metabolic rate, current blood glucose levels, project future blood glucose levels, body fat percentage, blood analysis, diet goals, previously consumed items (for example, which may have been too high in some diet component, which therefore should be minimized at a later time).

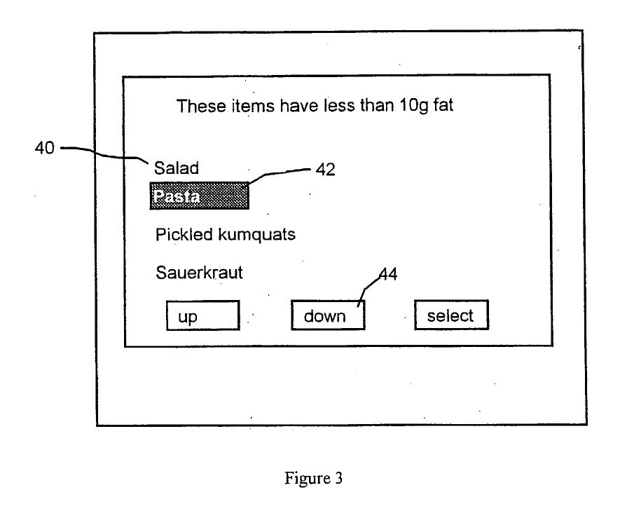

FIG. 3 shows a possible presentation on the display of the PDA from which the user may select a food option. In this case, only items with less than a certain fat content are displayed to the user. The menu shown can be of all items, may be categorized in some way, or can only show items selected from the total menu which are consistent with the user's food preferences. The items shown can be those with some parameter more or less than a certain value, e.g. points related to caloric fiber and fat content such as those in Weight Watchers programs. The parameter may also be calorie content, glycemic response, total fat content, sodium content, fiber content, whether the food choice is vegetarian or vegan, or other parameters. The effect of menu selections on future meal options and future weight goals, within the scope of the weight loss program, can also be presented to the user. The menu display can further show lists or tables of important nutritional information such as fat grams, along with a list of menu options.

Within a subset of food items consistent with the user's preferences, the order of displayed items may reflect for example: previous customer order frequency (popularity), price, calorie content, or some other nutritional parameter.

Referring to FIG. 3, the display window shows a list 40 having a selected item 42, with icons 44 with which the user interacts to scroll down or Up the menu, and select items. Within the list of FIG. 3, the selected item is shown as being a pasta dish 42. The selected (highlighted) menu choice, in this case pasta, can be ordered by selecting the item, or further nutritional information can be obtained at this point.

Selection of Items Within a Displayed List

An item can be selected from a displayed list using any convenient method, such as key entry, mouse use, stylus, roller jog dial, touch pad, or use of other tracking device.

Voice recognition can also be used to select items. The words displayed to the user will be a very small subset of a person's total vocabulary, so that word recognition accuracy is greatly enhanced. Alternatively, a number or some other code can be associated with each menu item, and the user may speak the number or code in order to choose the item. This method is described in more detail in co-pending U.S. Provisional Application No. 60/212,319 (filed Jun. 16, 2000), incorporated herein by reference.

A printed menu can also be given to the user within the restaurant. In this case, barcodes, optical character recognition, alphanumeric codes, or voice recognition, can be used to enter a menu choice into the PDA, so as to receive more detailed nutritional information, further information about the choice, or so as to order the chosen item.

The restaurant table may have a data port, display, interface for a PDA, or may have a PDA-like device for use by the user.

Nutritional Information Display

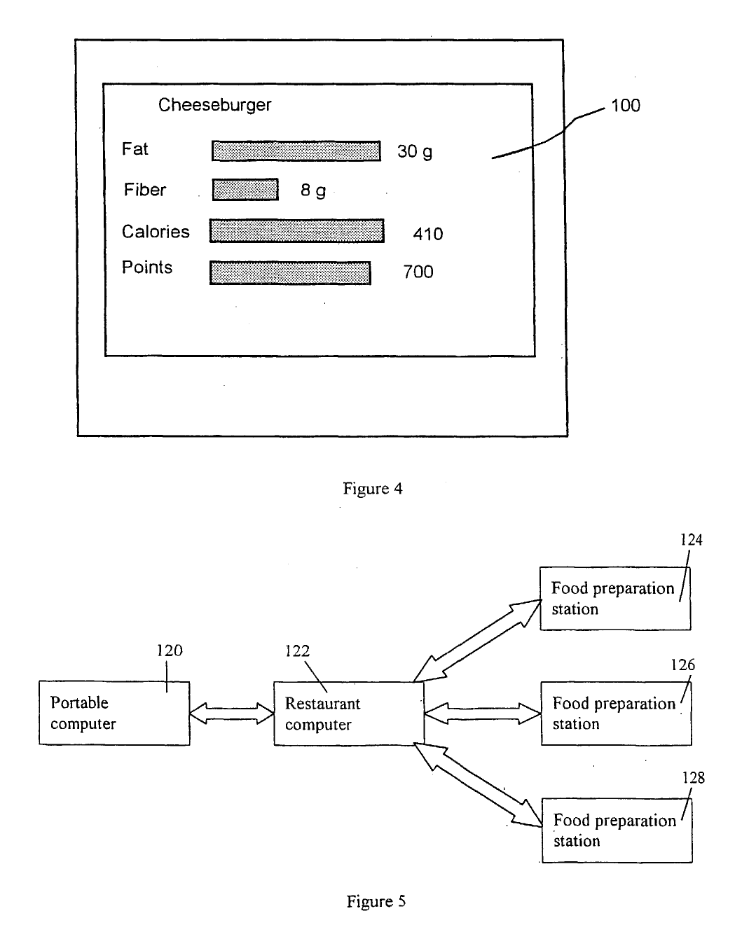

FIG. 4 shows a presentation on the display of a PDA. The displayed window 100 shows a variety of nutritional data for all the chosen menu items, in this case a cheeseburger. These include fat grams, fiber grams, calories, and a diet related parameter labeled as points. The points may be those described by Miller-Kovach in U.S. Pat. No. 6,040,531, incorporated herein by reference, used in Weight Watchers diet programs.

It is an important aspect of this invention that the nutrition information displayed for a chosen item is specific for the item served in the restaurant in which the user is located. The information for the cheeseburger illustrated in FIG. 4 is for the particular cheeseburger served in that restaurant, not for a generic item with average properties. Conventional diet logging systems generally present the user with a choice of generic items, whereas the improved system embodiments of the present invention allow for highly specific information to be recorded.

An image can also be presented to the user of the chosen item on the display of the PDA. If aroma generating means are available, these may also be used to present the aroma of the chosen item to the user.

Ordering Using the PDA

After selecting one or more items, and reviewing nutritional information, the user can place an order with the restaurant for the food selected. The order can be placed with a human waiter, robot with equivalent functionality, or with a computerized system. FIG. 5 shows a system by which the order can be placed using a computerized method. PDA 120 is in communication with restaurant computer 122, which in turn is in communication with a number of food preparation stations 124, 126 and 128. The user enters order data into the PDA, which is then transmitted over a preferably wireless connection to the restaurant computer 122. The restaurant computer is part of a system to facilitate food ordering, preparation, and delivery to customers. The restaurant computer directs the order request to an appropriate food preparation station. This enables work to be distributed between the food preparation stations in an efficient manner, and leads to an efficiency improvement over conventional systems. A location code, such as a table number, can also be transmitted from the PDA, associated with the food order. This allows the location code to be associated with the prepared food to allow convenient delivery.

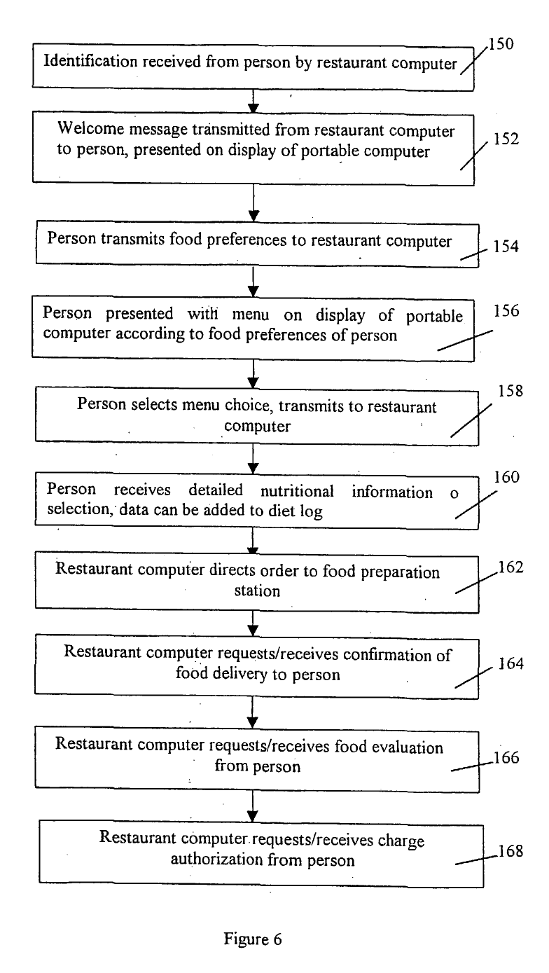

FIG. 6 is a flowchart showing a method by which a person can order food using the system of the present invention. Box 150 corresponds to the identification of the user by the restaurant computer on entering the restaurant. Box 152 corresponds to the transmission of a welcome message from the restaurant computer to the PDA. Box 154 corresponds to the transmission of preferences from the PDA to the restaurant computer. Box 156 corresponds to the transmission of a menu, consistent with the user preferences, from the restaurant computer to the PDA. Box 158 corresponds to the review of selected menu choices by the user. Box 160 corresponds to the transmission of menu choices from the PDA to the restaurant computer. Box 162 corresponds to the direction of the order to an appropriate food preparation station. Box 164 corresponds to the delivery of the meal to the user, and the transmission of a confirmation signal from the user to the restaurant computer. Box 166 corresponds to the transmission of an evaluation of the meal from the PDA to the restaurant computer. Box 168 corresponds to the transmission of a charge authorization from the PDA to the restaurant computer, so as to bill the cost of the meal to an account of the user.

Restaurant Provides PDA

In the examples above, the PDA is assumed to belong to the user. However, in other embodiments the restaurant itself can provide the PDA, for example as connected by a cable or wireless communication link to a central restaurant computer. The PDA supplied may provide automatic location information to the restaurant computer along with the order information.

Takeout Ordering

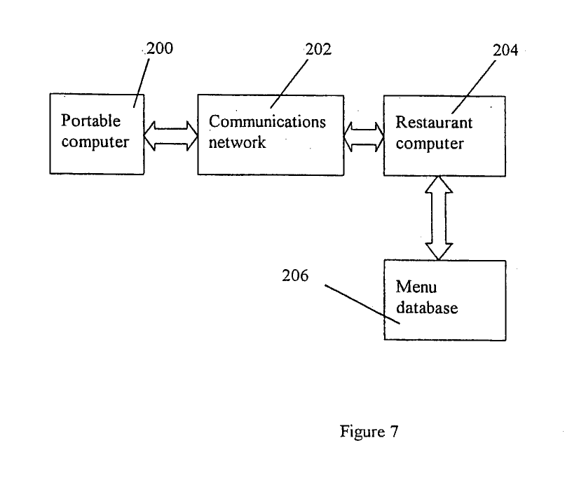

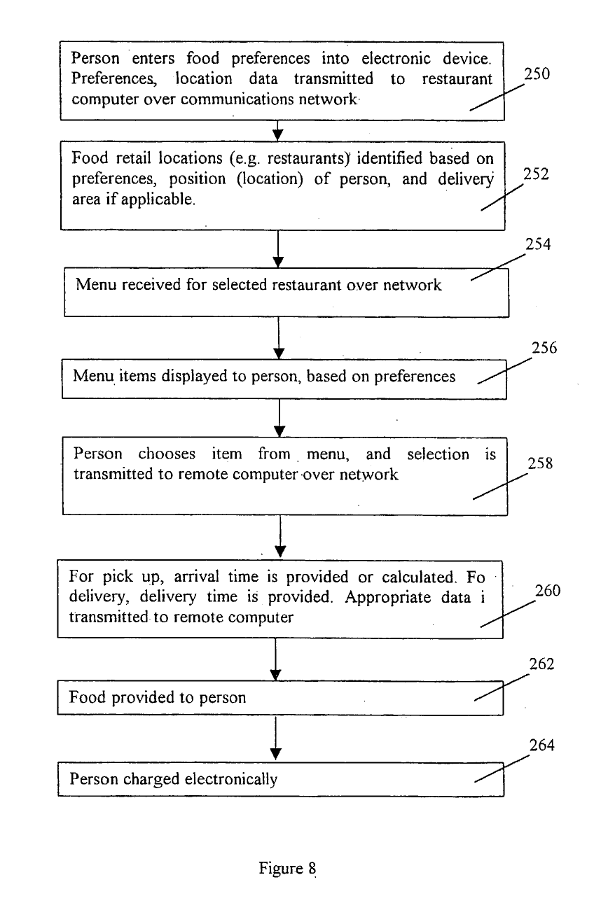

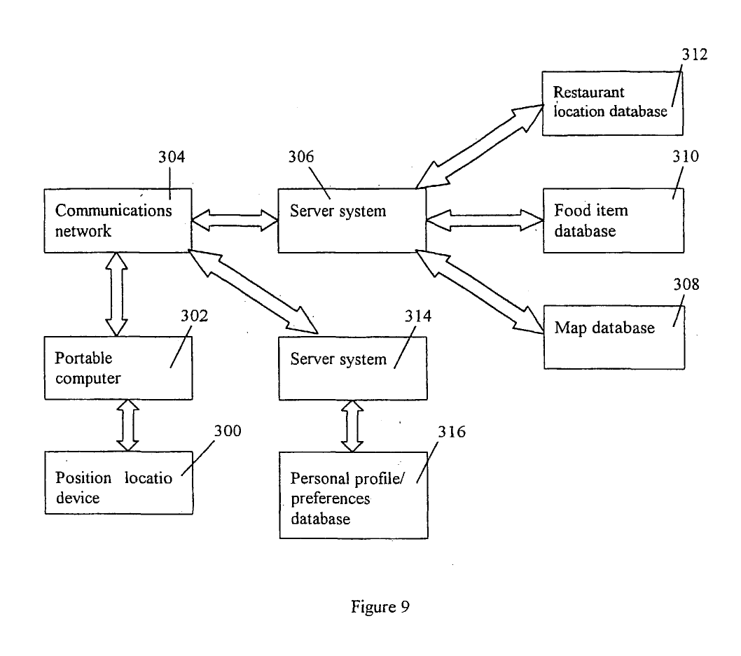

FIG. 7 shows a system which can be advantageously used for ordering food from a retail food establishment over a communications network. This system can be used for ordering food within the retail establishment itself, or from a remote location, for example for advance ordering and takeout ordering. FIG. 7 shows a computer 200 in communication with a restaurant computer 204 through a communications network 202. The restaurant computer is in communication with a menu database (or food item database) 206. FIG. 8 is a flowchart illustrating a method by which the user can order food. Box 250 corresponds to the user entering required information into a PDA. Box 252 corresponds to the location of a restaurant having a delivery area consistent with the user's present or future location. For example, the PDA may have a GPS system allowing the location of the user to be established, and hence correlated with the delivery area of restaurants from within a database. Alternatively, the user may enter a zip code or other geographical identifier to indicate a chosen area. Box 254 corresponds to the transmission of menu information from the restaurant computer to the user over the communications network. Box 256 corresponds to the display of selected items to the user, for example those consistent with the user's dietary preferences. Box 258 corresponds to the user choosing an item from the displayed menu. Box 260 is an optional step, in which a time is calculated for the travel of the user to the location of the food for pickup purposes. Box 262 corresponds to an order step by which information is transmitted from the PDA to the restaurant computer over the communications network. Box 264 is an optional step which may be carried out at a later time, whereby the user charges the cost of the ordered item to an account.

After delivery of the food, the user can provide feedback on the quality of the meal to the restaurant computer by entering data into the PDA, for example as part of a survey or questionnaire. This may be done during the meal or at some convenient later time. A discount may be given to the user for participation in the feedback process.

The user can record fractions of meals eaten for diet logging purposes. For example, the PDA can be provided with a weighing scale accessory, as fully described in co-pending U.S. Provisional Application No. 60/234,866 (filed Sep. 22, 2000) and U.S. application Ser. No. 09/669,125 (filed Sep. 25, 2002), the contents of which are incorporated herein by reference. The restaurant may provide meal weights, initial portion sizes, and remaining uneaten portion fractions.

When ordering by computer, user preferences can be automatically included within the order. For example, orders may specify no meat products, no animal products, and particular methods of preparation consistent with the user's preferences and/or dietary goals.

Portion Size

The portion size can be automatically scaled to the user's requirements. Excessive portion sizes are often a problem for persons on a weight control program. Using information provided by the PDA, portion size can be influenced for an order. For example, portion size can be scaled by the user's resting metabolic rate, for example as determined using an indirect calorimeter. Portion size may also be scaled by the user's daily calorie allowance, or by the remaining allowance from a daily allowance. If a person is counting some diet related parameter, such as Weight Watchers points, meals can be sized and adapted to the requisite number of points allowed for that meal. An advantage of the present system is that preferences can be discretely provided, without the need for verbal disclosure to a wait staff person. Hence, a method of determining portion size for a restaurant meal may comprise: receiving a menu preference from a user, receiving a metabolic rate from the user, and adjusting the portion size of the menu item according to the metabolic rate. A further method of portion size control within a restaurant may comprise: receiving a menu item preference from a user, receiving a calorie allowance from the user, and adjusting the portion size according to the calorie allowance. The calorie allowance may be determined by receiving the daily calorie allowance from the user, receiving previous consumed calories from the user for that day, and calculating the allowed calories remaining for that day.

Portion sizes can also be controlled by past, current, and/or future projections of a user's blood sugar level or hunger level, for example as described more fully in co-pending U.S. Provisional Applications No. 60/219,070 (filed Jul. 18, 2000), No. 60/228,680 (filed Aug. 29, 2000), and No. 60/269,063 (filed Feb. 15, 2001), the contents of which are incorporated herein by reference. For example, the PDA may be provided with application software adapted to record food eaten, periodic blood sugar level measurements, and to provide a model of glycemic response for the person, so as to project future levels of blood sugar based on previously consumed and planned meals. Hence, a person's menu choice may be approved or disapproved by the projections of such a model, or the portion size may be scaled according to the maximum allowable blood sugar.

For example, food selections which maintain blood sugar levels between acceptable bounds can be presented to the user via the display of the PDA. Hence, a further method of determining portion size might include the steps of assigning glycemic response parameters to menu options wherein the glycemic response parameters correlate with a time dependence of blood sugar increase for a person, receiving a current blood sugar level and a projected future blood sugar level for the person, receiving a scaling parameter from the person, wherein the scaling parameter relates to the person's individual metabolism of carbohydrates, determining an acceptable range of glycemic response parameters for future healthy levels of blood glucose for the person, choosing food items from a database based on the acceptable range of parameters, and transmitting the selected food items to the person for consideration.

System Embodiment With No Equipment Provided by Restaurant

The following system example does not require the restaurant to provide any computerized equipment. FIG. 9 shows a computer 302 having a global positioning unit 300, in communication with a server 306 via a communications network 304. The server 306 has access to a restaurant location database 312, a food database 310, and a map database 308. The computer is also in communication with a second server system 314 through the communications network 304, which has access to a user profile database 316.

As a person enters the restaurant, location data provided by the GPS unit 300 is transmitted over the communications network 304 to the server system 306. The identity of the restaurant is determined from comparison of the location data provided by the GPS system with data within the restaurant location database 312. Alternatively, the user may simply enter the name of the restaurant and address information into the computer. Using the identity of the restaurant menu, information is extracted from a food database 310 and transmitted from the remote server 306 through the communications network 304 to the user's computer 302. User preferences may be resident on the computer 302, so as to only present menu items consistent with the user preferences. Alternatively, the menu may be ordered so as to present items consistent with user preferences near the top, or in an otherwise prominent position. However, referring to FIG. 9, the user preferences can be stored within a remote database 316 accessible through second server 314. Hence, user preferences can be automatically received by server 306 so as to only supply food consistent with the user preferences to the computer 302.

User preferences can be used to restrict data transmitted to the user over the communications network. In other embodiments, full menu and nutrition information can be transmitted to the user's computer 302, and the software program resident on computer 302 used to choose foods based on the user's preferences, which may be stored in the memory of the computer 302.

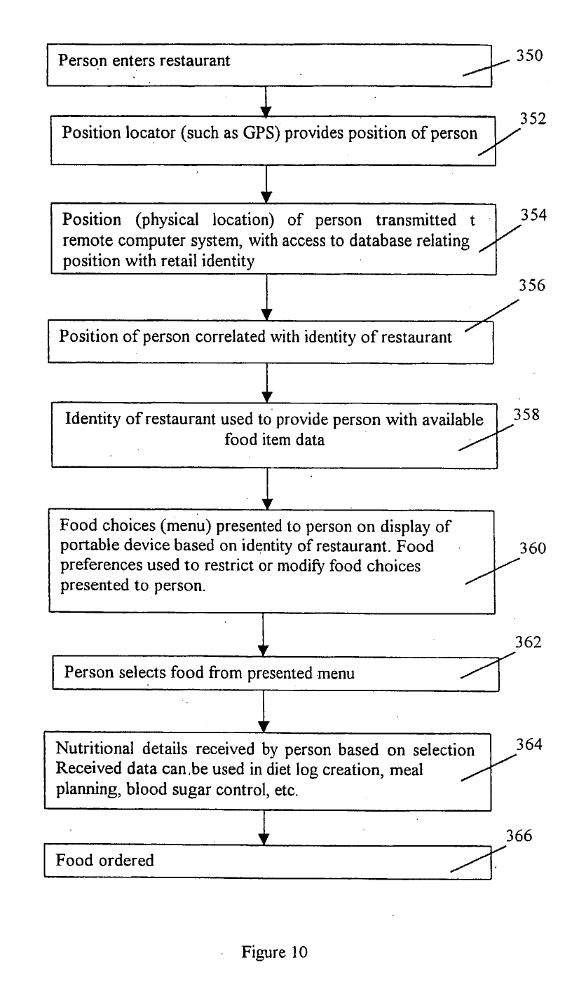

The user can select food items using the PDA and communicate the choice to the remote server. The user may then receive further information about the selected choices, such as full nutritional data, mineral contents, vitamin contents and the like. The user may also receive a discount, for example in the form of an authorization code received from the server 306 through communication network 304 and shown on the display of computer 302. FIG. 10 is a flowchart for a method of obtaining nutrition information. Box 350 corresponds to the user entering a restaurant. Box 352 corresponds to the user establishing their location using a GPS signal. Alternatively, the name, address, branch number, or similar location data can be used. Box 354 corresponds to the transmission of the location data to a remote server over a communications network. Box 356 corresponds to the correlation of the location data with restaurant identity, so as to establish the identity of the restaurant. Box 358 corresponds to the transmission of food data, such as a menu, from the remote server to the computer 302 over the communications network. Box 360 corresponds to the use of user preferences to restrict the displayed menu choices. Box 362 corresponds to the selection of food by the user. Box 364 is an optional step corresponding to the transmission of food selections to the server, so as to receive further nutritional information or other information as necessary. Box 366 corresponds to the ordering of food based on the information received. The system as displayed requires that the user orders food from a conventional wait staff, but the user has access to far more nutritional information than is conventionally the case. However, the system can also be readily adapted for use for ordering food within a restaurant. In this case, the order is transmitted from the computer 302 to a server 304 which may then be in communication with the restaurant, or may be the restaurant computer as discussed in previous embodiments. The food order so transmitted can then be conveyed to food preparation stations.

Hence, an improved method for a person to receive nutritional information and nutritional advice regarding food choices in a restaurant comprises the following steps. The person provides location data to a remote server computer over a communications network, preferably using a portable electronic device having a wireless transceiver and a position location device such as a GPS. The server computer correlates the location data with a restaurant identity, and transmits the restaurant identity and food information based on the restaurant identity over the communications network to the person. The person can then select a food item, for the purposes of ordering, payment, obtaining further nutritional information, and the like.

Diet Logging Software.

The portable electronic device carried by the user can be provided with diet logging software, such as described in U.S. Pat. Nos. 5,704,350 and 4,891,756 to Williams, incorporated herein by reference. The user receives nutritional information on the portable electronic over a communications network. The nutritional information for food eaten can be identified, for example, by selecting foods from menu lists, scanning barcodes on printed menus, or otherwise identifying the foods consumed. The nutritional information can then be entered into the memory of the electronic device as part of a diet log record, sparing the user from having to find the item within the options presented by the diet log software. Conventional diet log software presents generic food descriptions to the user. An improved diet log program is integrated with the software used to receive and review nutritional information over a communications network, so as to add the chosen item to a diet log. The nutritional information added to the diet log is specific to that meal, a great improvement over conventional diet logs.

Locating Restaurant

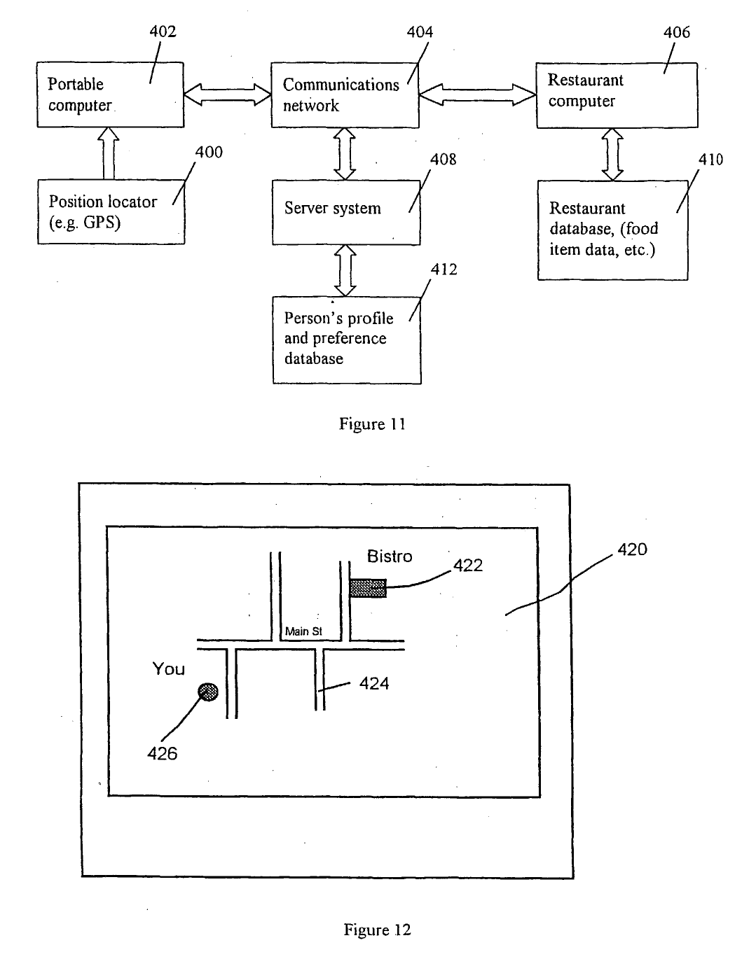

The following example relates to the location of a suitable restaurant, with respect to user dietary preferences. FIG. 11 shows a system embodiment of this example. The system comprises a GPS module 400 providing location data to a portable computer 402. The GPS module and portable computer may form a unitary device. The portable computer is in communication with first and second servers 406 and 408 through communications network 404. The first server 406 (or restaurant computer, which may be associated with a single restaurant, chain, or many restaurants) has communication with a restaurant database 410 and the second server has communication with user preference database 412. The GPS module provides the location data to the PDA, which then transmits the location data to the first server over a communications network. A software application program on the first server is used to correlate the location data with restaurant identity using the restaurant database 410. All restaurants in geographical proximity to the user can be transmitted back to the PDA for display. However, user preferences can be used to narrow down the displayed list or chart of restaurants so as to only include those that conform to the user's preferences. The first server 406 or the portable computer 402 may obtain user preference data from a memory of any computing device. In the example of FIG. 11, a user profile database is maintained on the second server 408, and can be accessed by the first server 406 so as to limit the data transmitted to the computer 402.

A software application program running on the first server is used to extract restaurant locations from the restaurant database. User preferences are either received from the PDA, or from user preference database 412, or from another source accessible over the communications network. The user preferences are then used to select acceptable restaurants from the database for transmission to the computing device 402. For example, only restaurants serving low fat meals may be presented to the user. Alternatively, all restaurants may be presented, but only those conforming to the user preferences will be presented in a prominent fashion. The addresses of the restaurants can be provided by the server 406, and used to generate directions to the restaurant for the user. FIG. 12 shows a map display having directions to a chosen restaurant. FIG. 12 illustrates a map 420 shown on the display of a portable computing device, the map showing the location of the chosen restaurant 422 (bistro), a street plan 424, and the current location of the user 426. The current location can be provided by a global positioning unit. Directions can also be given in the form of a list of directions, spoken commands as a user walks or drives towards the restaurant, or by some other convenient manner.

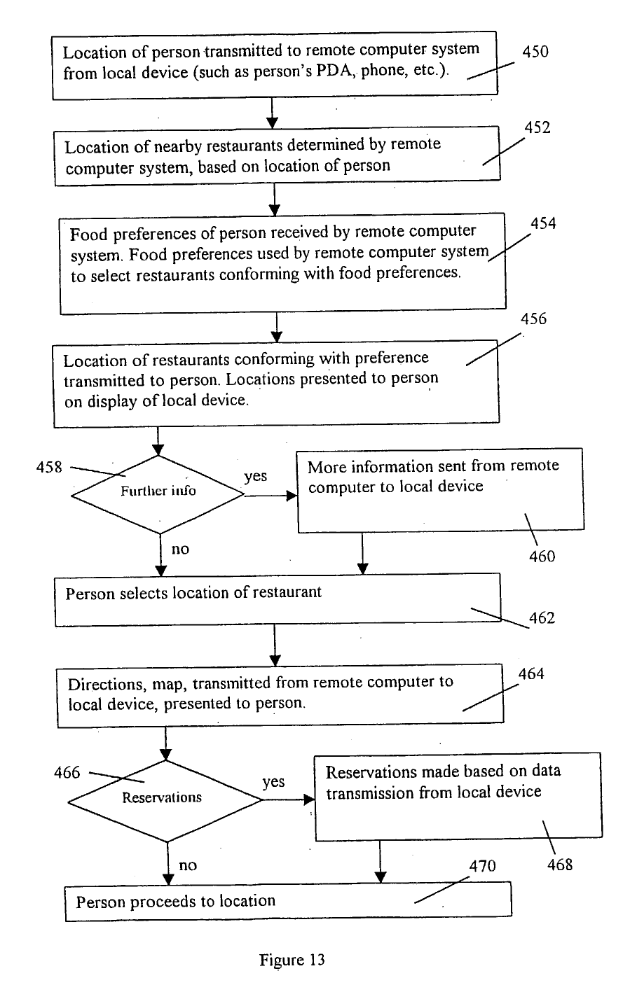

FIG. 13 shows a flowchart, which summarizes the method by which a user can be guided to a restaurant conforming to the user's preference. Box 450 corresponds to the establishment of the user's location. Box 452 corresponds to the transmission of the user's location to a remote server over a communications network, and the establishment of nearby restaurants using a database accessible by the remote server. Box 454 corresponds to the application of user preferences to the received restaurant information. Box 456 corresponds to the display of restaurant locations to the user. Diamond 458 corresponds to requesting more information. Box 460 corresponds to the provision of further information. Box 462 corresponds to the user choosing a location. Box 464 corresponds to the provision of directions to the user. Diamond 466 corresponds to requesting reservations. Box 468 corresponds to the making of reservations, and box 470 corresponds to the user proceeding to the chosen location.

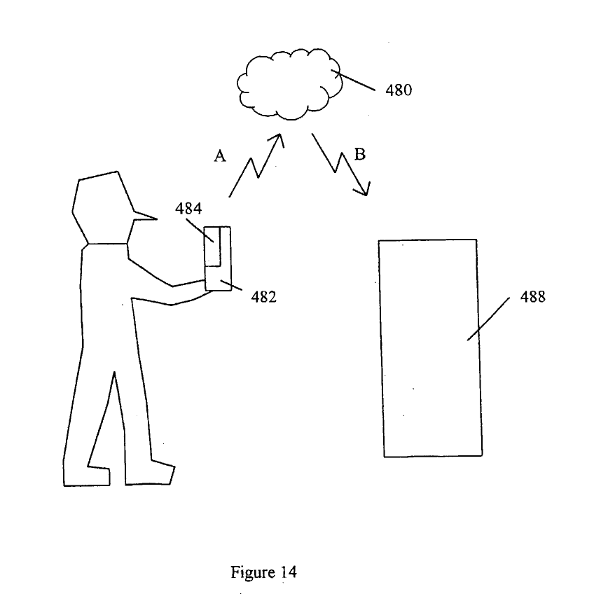

FIG. 14 is a further illustration of the system in use with the user 480 shown holding a PDA 482 with a display 484. The PDA has a wireless communication link represented by the arrow A to the Internet represented by the cloud symbol 486 and hence is in communication with remote server 488 using communications link B also represented by a jagged arrow.

Weight Control Program

A user can subscribe to a weight control program, supervised by a weight control business. Restaurants affiliated with the weight control program can supply meals approved by the business. Other business relationships may exist so as to allow approved meals to be provided.

In one example, the user carries a PDA with GPS capability. When wanting to eat, the user presses a button, so as to transmit location information to a remote web server over a communications link, preferably a wireless Internet connection. The remote server determines the locations of nearby participating restaurants, by correlating the location data with a database of participating restaurants. The list of participating restaurants is then transmitted to the portable computer, and displayed on a display, for example in the form of a map.

This function can be combined with route planning. Affiliated restaurants can be identified on a planned route and the menus accessible over a communications network. Hence, a person may plan a route by any transportation method to a destination, and be provided with locations and possibly reservations at affiliated restaurants at a convenient time and place on the journey. This system can be combined with discount schemes, frequent eater schemes and the like. Marketing, discount offers, user preferences and the like can be used to determine enhanced presentation of some restaurants on the display of the user's portable computing device.

Resting energy expenditure, or equivalently resting metabolic rate, is conveniently measured using an indirect calorimeter such as the gas exchange monitor (GEM), embodiments of which are described in co-pending U.S. application Ser. No. 09/630,398 (filed Aug. 2, 2000) and Ser. No. 09/674,897 (filed Nov. 7, 2000), and in published U.S. Pat. Nos. 6,135,107, 5,836,300, 5,179,958, 5,178,155, 5,038,792, and 4,917,108, the contents of all of which are incorporated herein by reference. Activity energy expenditure (AEE) can be estimated by measuring physiological parameters correlated with activity, as described in co-pending U.S. application Ser. No. 09/684,440 (filed Oct. 10, 2000), and co-pending U.S. Provisional Application No. 60/225,101 (filed Aug. 14, 2000), the contents of all of which are incorporated herein by reference. For example, pedometers, pulse rate monitors, and other physiological sensors can be correlated with the enhanced metabolic rate due to physical activity. Hence, an integrated weight control program can be devised in which diet advice provided by the portable computer, such as the calorie allowance for a meal, is influenced by the metabolic information provided by the indirect calorimeter or any activity sensors that the person uses. Hence, after a period of intense activity, the calorie allowance for the next meal can be increased, and this may be reflected in a wider variety of menu items being presented to the user.

Supply of Equipment

The following is an example of a business model by which the invention could be implemented in relation to weight control. A weight-loss company runs a weight-loss program. A user subscribes to the program (e.g. by a monthly fee), and receives a PDA, possibly equipped with Bluetooth wireless communication means, and/or a wireless Internet connection. Restaurants participating in the program may be equipped with devices, which can communicate with the PDA, preferably using Bluetooth. The restaurants pay a licensing fee to the weight-loss company. The weight-loss company maintains a database of participating restaurants, available through a web-site on the Internet. The user can access this database to help select a restaurant, using the PDA or other device communicating with the Internet, or by plugging a memory module into the PDA. Restaurants could display a sign or emblem in their window indicating participation in the weight-loss program. Restaurants supply the nutrition information related to menu options. The nutrition information is accessed by the user with the PDA, either from the restaurant (using e.g. a wireless link, memory module etc.) or from an Internet web site. The restaurant may prepare modified versions of menu options (e.g. low fat or low salt meals) with the modifications reflected in the nutrition information. Modified portion sizes may also be available, with the nutrition information pro-rated. The restaurant could prepare modified versions of menu options, such as low fat or low salt meals, with the modifications reflected in the nutrition information. The PDA records the menu items chosen by the user. The restaurant may pay a commission on the meal to the weight loss company. The PDA can also act as a credit device, charging meals to the user through some mechanism (e.g. automatic charge to a line of credit through a wireless link to a network, or charge against a user's account maintained by the weight-loss company).

In other embodiments, user preferences can relate to items other than food, such as other goods and services, and these preferences can be used modify the presentation of information relating to these goods and services to the user. Examples include medical treatment, tourist activities, automobile services, aviation services, other transportation services, business activities, accommodations, sports, recreation, and the like. If the user maintains a diet log on the portable electronic device, the diet log software can identify nutritional deficiencies in previous meals. For example, if previous meals were low in vitamin C, the diet log software can generate a food preference for meals high in vitamin C.

The current invention is not to be restricted by the described examples. Other embodiments will be clear to those skilled to those skilled in the art.

Having described my invention, I claim:

1. A portable computing device for assisting a person to locate a food retailer according to a food preference of the person, comprising:
a display; a processor; a data entry mechanism; a memory;
a wireless transceiver adapted to communicate with a communications network;
a position location device adapted to provide a position of the person; and
a software application program running on the portable computing device adapted to receive the food preference from the person; to transmit the food preference and the location of the person to a remote computer system over the communications network; to receive food retail data from the remote computer over the communications network, wherein the food retail data comprises food retailer location data and food item data associated with each food retailer location; and to display food retailer location data and food item data to the person on the display of the computing device.

2. The portable computing device of claim 1, wherein the software application program is further adapted to allow the person to select a single food retailer location, and to display food item data associated with the single food retailer location in the form of a menu.

3. The portable computing device of claim 1, wherein food item data displayed to the person is restricted to food item data consistent with the food preference of the person.

4. The portable computing device of claim 1, wherein the food item data includes nutritional information.

5. The portable computing device of claim 1, wherein the software application program allows selected food item data to be recorded in a diet log for the person.

6. A method for assisting a person to locate a food retail location according to a food preference of the person, the method comprising:
providing a computer system, the computer system having access to a database associating food retail location data with food item data, wherein food item data comprises nutritional information;
receiving the food preference and a position for the person;
determining one or more food retail locations close to the position of the person;
comparing food item data associated with each food retail location with the food preference;
presenting food retail location data to the person, wherein each food retail location presented to the person is associated with food items consistent with the food preference.

7. The method of claim 6, wherein the computer system comprises a portable computing device having a data entry mechanism, a processor, a memory, a display, a location device providing a position of the person, a wireless transceiver adapted to communicate with the database associating food retail location data with food item data over a communications network, and a software application program adapted to receive the food preference from the person and to present the food retail location data to the person on the display.

8. The method of claim 6, further comprising receiving a chosen food retail location from the person, and presenting a list of food items available at the chosen food retail location and consistent with the food preference.

9. The method of claim 8, further comprising the transmission of directions to the food retail location to the person.

10. A system for allowing a person to obtain nutritional information related to food available at a food retailer, the system comprising:
a portable computing device having a display; a data entry mechanism; a first wireless transceiver; a processor; a memory; and a software application program adapted to receive a food preference from the person, to store the food preference in the memory, and to cooperate with the transceiver so as to transmit the food preference to devices in transmission range of the transceiver;
a restaurant computer, having a second wireless transceiver, a processor, and a memory, the restaurant computer being adapted to communicate with the portable computing device when the portable computing device within transmission range of the second wireless transceiver, the restaurant computer being adapted to transmit food item descriptions and associated nutritional data to the portable computing device and to receive the food preference from the portable computing device;
whereby the person can view food item descriptions and nutrition information on the display of the portable computing device, and can view a display emphasizing food item descriptions having nutritional data consistent with the food preference.

11. The system of claim 10, wherein the restaurant computer is further adapted to transmit to the portable computing device selected food item descriptions having nutritional data consistent with the food preference received from the portable computing device.

12. The system of claim 10, wherein the restaurant computer is further adapted to receive a food order from the portable computing device.

13. The system of claim 10, wherein the portable computing device is further adapted to record food items ordered by the person, and to record nutrition data associated with ordered items in a diet log for the person.

14. The system of claim 10, wherein the restaurant computer is further adapted to receive a charge authorization from the portable computing device, corresponding to payment for food items provided to the person.

15. A method for viewing nutritional data associated with food items available from a food retailer, the method comprising:
transmitting a position from a portable electronic device to a remote computer system over a communications network, wherein the portable electronic device has a position locator, a display, and a transceiver, and wherein the remote computer system has access to a database associating the position with a food retailer identity and with a food selection list, wherein the food selection list comprises food identifiers and associated nutrition data;
receiving the food retailer identity and food selection list from the remote computer over the communications network so as to view the food retailer identity and food selection list on the display of the portable electronic device.

16. The method of claim 15, further comprising the transmission of a food preference from the portable electronic device to the remote computer system over the communications network, wherein the food preference is used to modify the food selection list received from the remote computer.

17. The method of claim 18, further comprising the receiving of location data associated with items on the food selection list from the remote computer.

18. The method of claim 15, wherein the remote computer system is further adapted to receive a food order from person using the portable electronic device.

19. The method of claim 15, wherein the remote computer system is further adapted to receive a payment authorization transmitted by the portable electronic device.

20. The method of claim 15, wherein the portable electronic device is further adapted to store a food preference for the person, the food preference being used to modify the display of the food selection list to the person.
